(19) United States
(12) Patent Application Publication
(10) Pub. No.: US 2005/0066459 A1
(43) Pub. Date: Mar. 31, 2005

(54) Electric toothbrushes and replaceable components

(75) Inventors: Aleksey Mikhailovich Pinyayev, West Chester, OH (US); John Geoffrey Chan, Loveland, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/887,644

(22) Filed: Jul. 9, 2004

Related U.S. Application Data
(63) Continuation-in-part of application No. 10/832,168, filed on Apr. 26, 2004.
(63) Continuation-in-part of application No. 10/842,302, filed on May 10, 2004.
(63) Continuation-in-part of application No. 10/847,429, filed on May 17, 2004.
(60) Provisional application No. 60/501,266, filed on Sep. 9, 2003.

(51) Int. Cl. A61C 17/22

(52) U.S. Cl. 15/28; 15/22.1; 433/29

(57) ABSTRACT

Disclosed is an electric toothbrush having an electrically powered element disposed on the head, and at least one removable and replaceable component. In particular is disclosed an electric toothbrush having removable and replaceable bristle holder, which can be removed and replaced without removing the electrically powered element from the head of the toothbrush.

### CROSS REFERENCE TO RELATED APPLICATION

This application is a continuation in part of application Ser. No. 10/832,168 filed on Apr. 26, 2004, and application Ser. No. 10/842,302 filed on May 10, 2004, and application Ser. No. 10/847,429 filed on May 17, 2004 and application Ser. No. not assigned (P&G Case 9357MRR), filed on Jul. 9, 2004 and application Ser. No. not assigned (P&G Case 9357MR3) and claims the benefit of U.S. provisional application Ser. No. 60/501,266 filed on Sep. 9, 2003, all of which are herein incorporated by reference.

### FIELD OF THE INVENTION

The present invention relates to electric toothbrushes that utilize an electrically powered element on the head of the toothbrush. In some versions of the toothbrush, components of the brush head are replaceable.

### BACKGROUND OF THE INVENTION

Generally, the present invention relates to an oral care implement having one or more electrically powered elements disposed on the head including, but not limited to, light emitting diodes, light-emitting elements using incandescent elements, laser elements, halogen elements, neon elements, fluorescent elements, plasma elements, xenon elements, flossing elements, massaging elements, scraping elements, heat emitting elements, sonic wave emitting elements, ultra-sound emitting element, electric current emitting elements, substance emitting elements and/or any combination thereof. Such oral care implements can include, but are not limited to, electric toothbrushes, powered flossers, tooth polishers, gum massagers, etc. Traditionally, electrically powered elements can be expensive, and can have a life span which exceeds the traditional life span for bristles on the head of a toothbrush. Electric toothbrushes can have replaceable heads, however if the electrically powered element is disposed on the head of the toothbrush, replacing the head also results in replacing the electrically powered element. The electrically powered element may not need replacing at the same time as the bristles and/or other components on the toothbrush head need replacing, and therefore, it is desired to be able to replace the bristles and/or other components on the head of the toothbrush without replacing the electrically powered element. However, replacing the bristles and/or other components on the head without replacing the electrically powered element requires that the bristles and/or other components can be removable and/or replaceable without interfering with and/or damaging the electrically powered element disposed on the head of the toothbrush. Additionally, the components can be removable and/or replaceable without severing the electrical connection between the electrically powered element and the battery.

Therefore, a recognized consumer need is an electric toothbrush, comprising an electrically powered element disposed on the head of the toothbrush that has removable and/or replaceable components that allow the consumer to remove and/or replace the components without replacing the electrically powered component.

### SUMMARY OF THE INVENTION

The present invention provides an electric toothbrush comprising: a handle, a head, and a neck extending between the handle and the head, the handle defining a hollow interior region, the electric toothbrush having a longitudinal axis; the head comprising at least one electrically powered element; a motor disposed in the hollow interior region defined in the handle, which is electrically connected to the electrically powered element; and at least one component wherein the component can be removed and replaced without removing the electrically powered element from the head of the toothbrush.

### BRIEF DESCRIPTION OF THE DRAWINGS

The invention may take physical form in certain parts and arrangements of parts, embodiments of which will be described in detail in this specification and illustrated in the accompanying drawings which form a part thereof, and wherein:

FIG. 1 is a perspective view of an electric toothbrush in accordance with the present invention.

FIG. 2 is a top planar view of the electric toothbrush of FIG. 1

FIG. 3 is a cross-sectional side view of the electric toothbrush of FIG. 1

FIG. 4 is a partial exploded perspective view of an embodiment of the toothbrush made according to the present invention illustrating certain components and their assembly.

FIG. 5 is a partial exploded perspective view of an embodiment of the toothbrush made according to the present invention illustrating certain components and their assembly.

FIG. 6 is a partial exploded perspective view of an embodiment of the toothbrush made according to the present invention illustrating certain components and their assembly.

FIG. 7 is partial exploded perspective view of a head and neck portion and components of an electric toothbrush made according to the present invention.

FIG. 8 is partial exploded perspective view of a head and neck portion and components of an electric toothbrush made according to the present invention.

FIG. 9 is a front view of a head and neck portion of the electric toothbrush of FIG. 8.

FIG. 10 is a side view of an electric toothbrush in accordance with the present invention.

FIG. 11 is a side view of the electric toothbrush of FIG. 10.

FIG. 12 is a cross-sectional side view of the head and neck portion and components of an electric toothbrush.

FIG. 13 is a top elevational view of a bristle holder made according to the present invention.

FIG. 14 is a perspective view of an elastomeric component for use on the electric toothbrush made according to the present invention.

FIG. 15 is a perspective view of an elastomeric component for use on the electric toothbrush made according to the present invention.

FIG. 16 is a perspective view of an elastomeric component for use on the electric toothbrush made according to the present invention.

FIG. 17 is a perspective view of an elastomeric component for use on the electric toothbrush made according to the present invention.

FIG. 18 is a perspective view of an elastomeric component for use on the electric toothbrush made according to the present invention.

FIG. 19 is a perspective view of a polishing cup for use on the electric toothbrush made according to the present invention.

FIG. 20 is a perspective view of a flosser for use on the electric toothbrush made according to the present invention.

FIG. 21 is a cross-sectional side view of a head and neck of an electric toothbrush made according to the present invention.

FIG. 22 is a perspective view of an oral care implement made in accordance with the present invention.

### DETAILED DESCRIPTION OF THE EMBODIMENTS

Generally, the present invention relates to an oral care implement for use in the mouth having one or more electrically powered elements disposed on the head including, but not limited to, light emitting diodes, light-emitting elements using incandescent elements, laser elements, halogen elements, neon elements, fluorescent elements, plasma elements, xenon elements, flossing elements, massaging elements, scraping elements, heat emitting elements, sonic wave emitting elements, ultra-sound emitting element, electric current emitting elements, composition emitting elements and/or any combination thereof. Such oral care implements can include, but are not limited to, electric toothbrushes, powered flossers, tooth polishers, gum massagers, etc. As used herein the term electrically powered element includes any electrically powered element that can convert electrical energy at the place where the element is disposed. For example, a light emitting element can convert electrical energy into light at the location where the element is disposed; such as on the head of an electric toothbrush. For simplicity's sake, hereinafter the present invention will be discussed as embodied in an electric toothbrush having a head on which a light emitting element is disposed. However it is contemplated that the invention can be an oral care implement that does not comprise bristles. In addition to an electrically powered element, an electric toothbrush made according to the present invention can further comprise one or more movable bristle holders, an optional one or more static bristle holder(s), a drive shaft, a motor, a power source such as a battery, and can comprise additional removable and/or replaceable elastomeric or non-elastomeric components.

The electric toothbrushes of the present invention can be used as part of a personal hygiene regimen to clean one's teeth and gums using a motorized movement, while the light-emitting elements illuminate the region of brushing, including the teeth and/or gums. Additionally, the light emitted from this electric toothbrush can be used to activate different properties in substances located in the oral cavity. The present invention relates to an electric toothbrush having replaceable and/or removable portions of the head and/or neck, including but not limited to a removable and/or replaceable front bristle bearing plate, bristle holders, or additional components such as melamine-formaldehyde foam, flossers, scrapers, gum massagers, scraping components, polishing cups, rubber picks, and/or any combination thereof. Having these removable and/or replaceable components allow the user to remove and/or replace the various components of the toothbrush when the components are worn or when the consumer desires a different component on the head of the toothbrush.

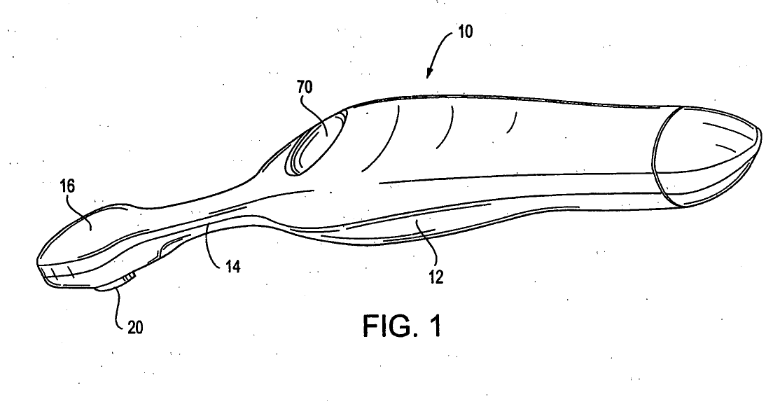

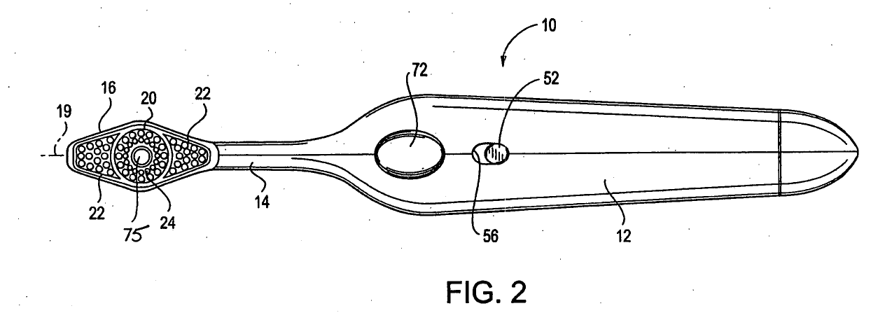

In one embodiment of the present invention, as shown in FIGS. 1 and 2 the electric toothbrush 10 includes an elongated body portion or handle 12, a head 16, and a neck 14 extending between the head and the handle. This embodiment of the electric toothbrush comprises a movable bristle holder 20 and gripping portions 70 and 72. This embodiment of the present invention also comprises, as shown in FIG. 2, a longitudinal axis 19, static bristle holder(s) 22, and an electrically powered element 75 disposed in the center of an oscillating bristle holder 20 comprising bristles 24.

A bristle holder is a component of the brush on which bristles are disposed. A bristle holder can be either static or moving. A static bristle holder is not operatively connected to a drive shaft. Alternatively, a movable bristle holder is a bristle holder that is operatively connected to a drive shaft, which is connected to the motor. Bristles can be disposed on the bristle holders. The type of motion provided by the electric toothbrushes of the present invention can be widely varied. The movable and/or static bristle holders and the arrangement of the bristles disposed thereon can also be widely varied. For example, the static bristles might partially or wholly circumscribe the moving bristle holders or may be disposed in a gap between multiple moving bristle holders. Examples of some bristle holder motions and bristle arrangements suitable for use with the present invention are described in US 20030126699; US 20030084525; US 20030084524; US 20030084526; and WO 03/063723; and WO 03/063722. The bristles can be made from conventional non-elastomeric materials, such as polyethylene, or can be made from elastomeric materials such as natural or synthetic rubbers, polyolefins, polyetheramides, polyesters, styrenic polymers, polyurethanes, etc., or a combination of materials.

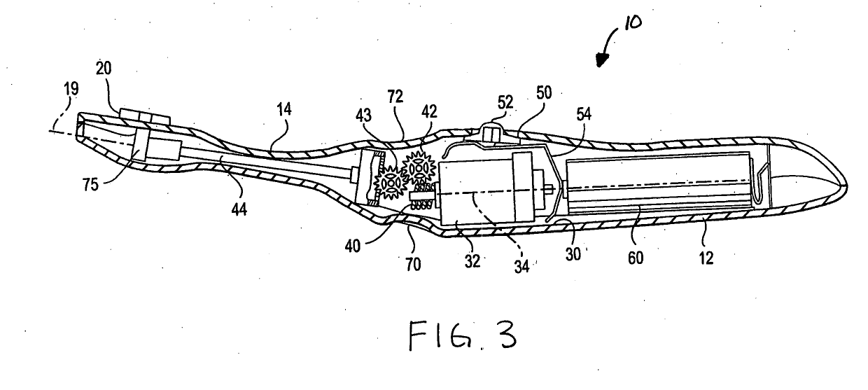

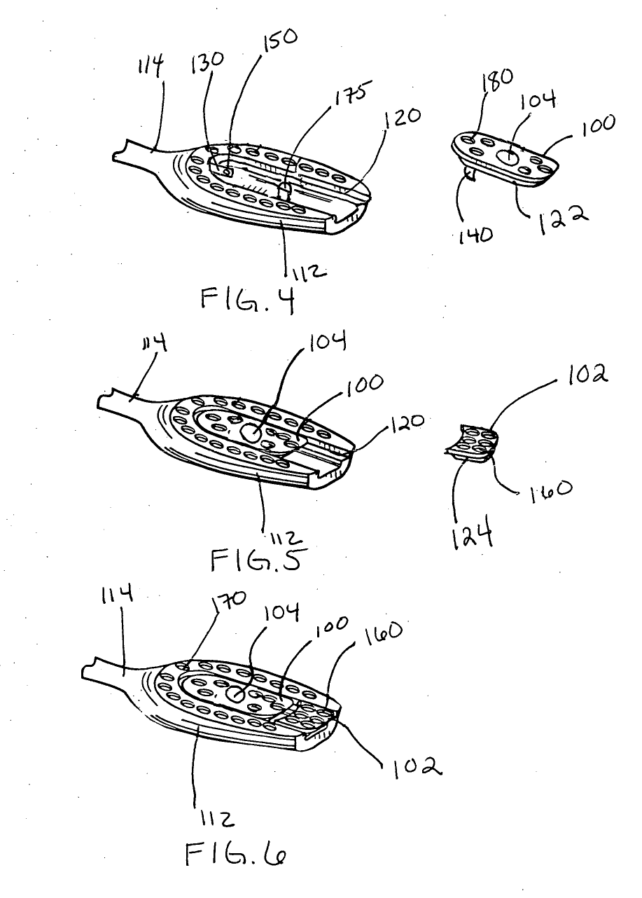

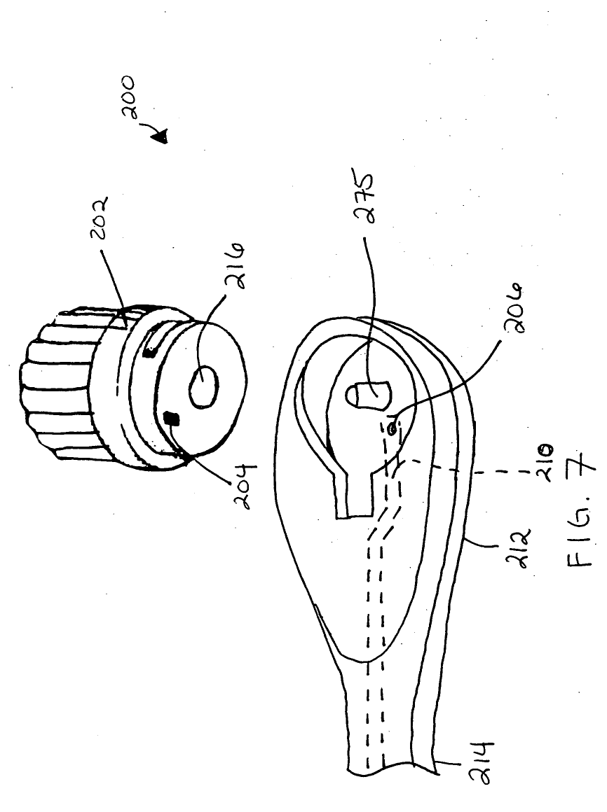

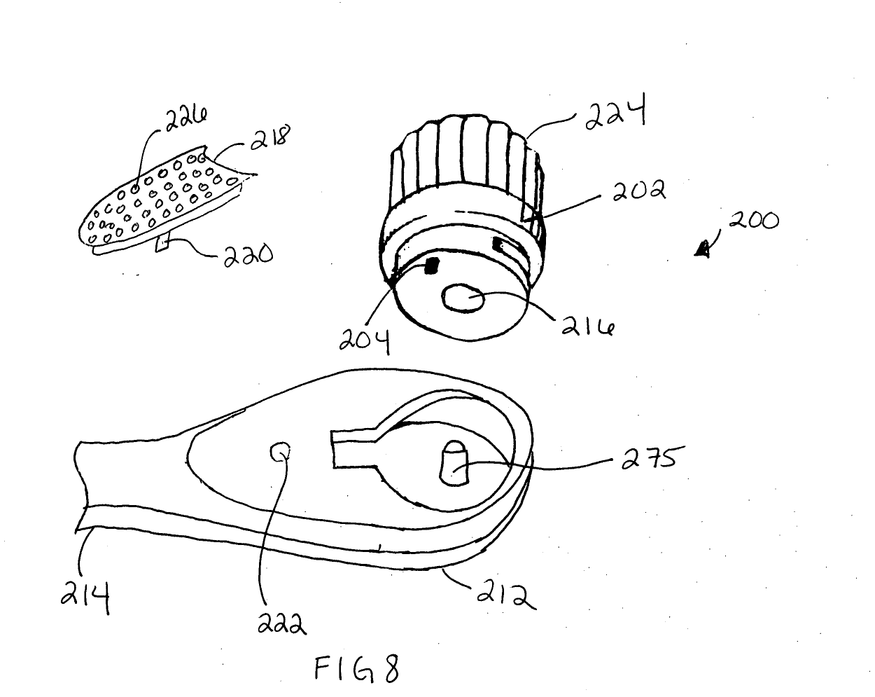

As shown in FIG. 3, the handle 12 further includes a hollow interior region 30 which houses a motor 32. The hollow interior region 30 generally extends along an axis 34 and retains the motor 32 and one or more electrical power sources such as a battery 60. Switching elements or contacts 50 and 54 can be utilized in conjunction with the switch 52 to selectively operate the motor 32 and the electrically powered element 75. In this embodiment the motor 32 powers the moving bristle holder 20 through a rotatable shaft 44. The shaft 44 rotates or oscillates about an axis 19. A gearing arrangement is operatively interconnected between the shaft 44 and the motor 32. The gearing arrangement includes a worm gear 40 and a pair of step gears 42, 43. The motor 32 is operatively connected to the worm gear 40. Step gear 42 is operatively connected to step gear 43 and the worm gear 40. The light emitting element 74 is disposed in the interior of the toothbrush head. A switch 52 is provided to control operation of the electric toothbrush and is operatively connected to the motor 32. The switch 52 is also configured to operate the one or more light emitting elements of the toothbrush. Such operation can be momentary or continuous. When the switch 52 is closed, a circuit is completed between the battery 60 provided within the hollow interior region 30 of the handle 12 and the motor 32 and electrically powered element 75.

A motor is operatively connected to the moving bristle holder when some action by the motor results in a response in the moving bristle holder. A physical connection is not required. A shaft may extend from the motor through the neck and into at least a portion of the head. The shaft may rotate, oscillate, linearly reciprocate, gyrate, vibrate or orbit when driven by the motor in order to impart one or more motions to the moving bristle holders. A gearing arrangement can be provided between the motor and the shaft or between the shaft and the moving bristle holders in order to impart motion thereto. Exemplary shaft and/or gearing arrangements are shown in U.S. Pat. Nos. 6,360,395 and 5,617,601 and application WO 03/079358 as well as in other patents and patent publications referenced herein. A magnetic driver can also be used to impart a vibrating motion to the toothbrush bristles as disclosed in U.S. Pat. No. 5,189,751. Additional examples of electric toothbrushes that vibrate are shown in U.S. Pat. Nos. 5,189,751, 5,544,382, and 5,448,792.

The handle also has a power source, such as one or more batteries, disposed therein for powering the motor and the light-emitting elements. Alternatively, the electric toothbrush may be connected to an external power source for powering the motor and light emitting elements.

The removable and/or replaceable components of the toothbrush include, but are not limited to, front bristle bearing plate, bristle holders, or additional components such as melamine-formaldehyde foam, flossers, scrapers, gum massagers, scraping components, polishing cups, rubber picks, as well as other elastomeric or non-elastomeric components and/or any combination thereof. The removable and/or replaceable components of the present invention can snap fit and/or slidingly engage the electric toothbrush such that they can be removed and/or replaced as desired without replacing the electrically powered element also disposed on the head of the toothbrush. Additionally, these components can have apertures, or portions that are translucent and/or transparent thereby allowing the electrically powered element disposed on the head of the toothbrush to emit through the component and/or from the head of the toothbrush. The components can directly engage the head of the toothbrush or can be disposed on a holder. Additionally, a combination of the components can be disposed on a single holder.

In one embodiment the removable and/or replaceable component of the electric toothbrush is at least one bristle holder. The bristle holders can individually snap and/or slide on and off the head of the toothbrush. The electric toothbrush of the present invention can have multiple removable and/or replaceable bristle holders, or one single bristle holder that can snap and/or slidingly engage the head. Both the movable and the static bristle holders can be removable. Additionally, the movable bristle holders can engage the head and operatively connect to the drive shaft. In one embodiment having a reciprocating movable bristle holder, as shown in FIG. 4-6, the head 112 of the toothbrush receives a movable bristle holder 100 and a static bristle holder 102. The movable bristle holder 100 slidingly engages the head of the toothbrush via channel 120. The rail(s) 122 disposed on the movable bristle holder 100 is received with the channel(s) 120 disposed on the head 112 of the toothbrush. The movable bristle holder 100 reciprocates when operatively connected to the drive shaft 130. The movable bristle holder 100 connects to drive shaft 130 via a protuberance 140 which engages an aperture 150 within the drive shaft 130. When the movable bristle holder slidingly engages the head of the toothbrush the protuberance on the movable bristle holder can be received within the aperture of the drive shaft; thereby operatively connecting the movable bristle holder to the drive shaft. An electrically powered element, such as light emitting element 175 is disposed within the head such that the movable bristle holder slides over the top of the light emitting element 175. The movable bristle holder 100 can further comprising and aperture 104 or transparent and/or translucent portion through which the electrically powered element can emit. The head 112 of the toothbrush can also receive a static bristle holder 102 via channel(s) 120. The rail(s) 124 disposed on the static bristle holder 102 is received within the channel(s) 120 disposed on the head 112 of the toothbrush. In this embodiment the removable and/or replaceable components are static and movable bristle holders. The movable bristle holder further comprises apertures 180 into which bristles can be disposed. Additionally, bristles can be disposed in apertures 170 on the head of the toothbrush, and apertures 160 on the static bristle holder. In another embodiment as shown in FIGS. 7-9 the movable bristle holder oscillates. In this embodiment 200 the movable bristle holder 202 snaps onto the head 212 of the toothbrush. The bristle holder further comprises a protuberance 204 which is received within aperture 206 of the drive shaft 210; thereby operatively connecting the movable bristle holder 202 to the drive shaft 210. The movable bristle holder 202 also comprises an aperture 216. When the movable bristle holder is placed onto the head 212 of the toothbrush, the light emitting element 275 fits into, and can shine through this aperture as illustrated in FIG. 9. This embodiment of the toothbrush can also comprise a static bristle holder 218 as shown in FIG. 8. This static bristle holder can snap or slide onto the head of the toothbrush. In this embodiment the static bristle holder comprises a protuberance 220 which fits into aperture 222 on the head 212 of the toothbrush. The movable bristle holder 202 can further comprise bristles 224. The static bristle holder 218 can comprise bristles disposed in apertures 226.

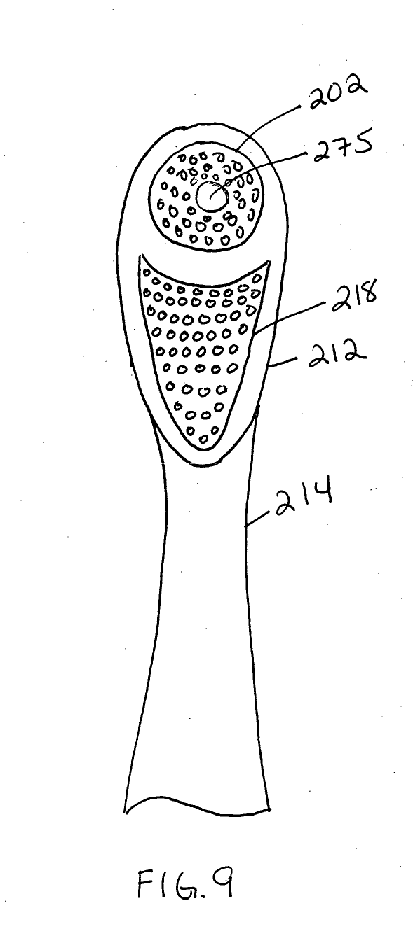

In another embodiment of the present invention the removable and/or replaceable component is the front bristle bearing plate of the toothbrush. The front bristle bearing plate is the front half of the casing that forms the head and neck portion of the electric toothbrush. The front half of the casing can comprise the bristles, as well as any other component disposed on the head of the toothbrush. Alternatively, the back half of the casing comprises the electrically powered element and the drive shaft. In this embodiment the front bristle bearing plate snaps on and off the electric toothbrush. This allows the bristles and other components to be replaced without replacing the electrically powered element. Additionally, this opens up the head of the toothbrush, which can ease the replacement of the electrically powered element, as it allows access to the electrically powered element. In this embodiment 300 the front bristle bearing plate 302 can then engage the back half of casing 304 of the toothbrush 300 as shown in FIGS. 10-11. In this embodiment the front bristle bearing plate engages the back half of the casing by a snap fitting. The bristle bearing portion has protuberances 306 which fit into apertures 308 disposed on the back half of the casing. It is also contemplated that the back half of the casing can have protuberances which fit into apertures disposed on the front bristle bearing plate. However, it is also contemplated that the front bristle bearing plate could slide on and off via a channel and rail fitting.

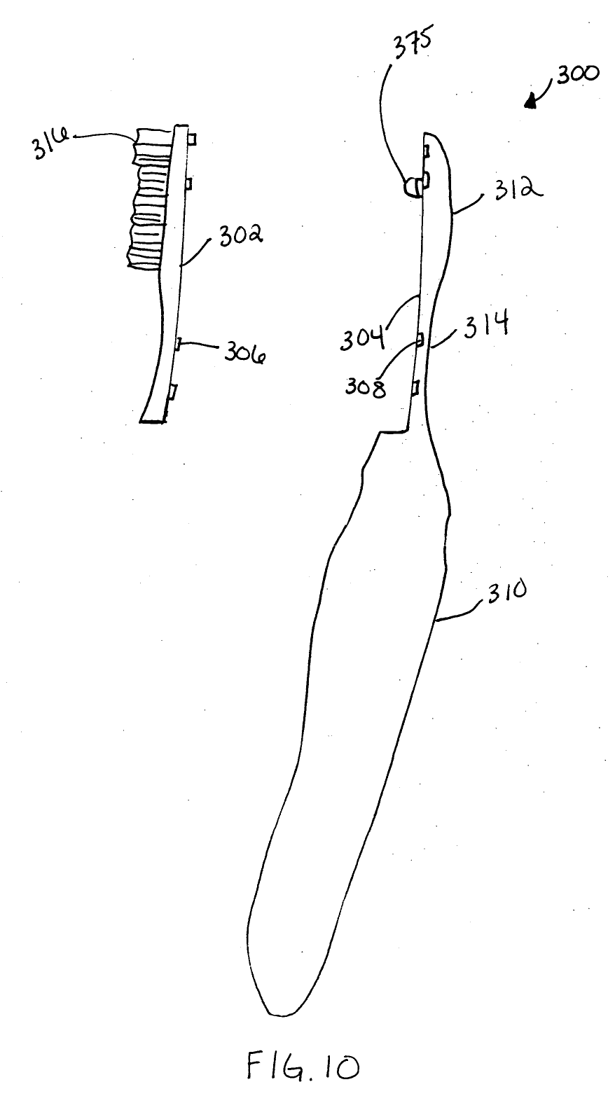

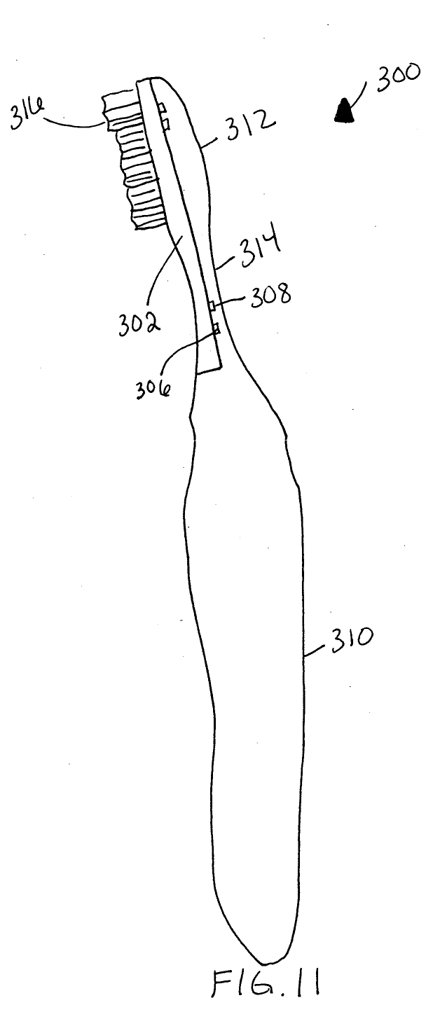

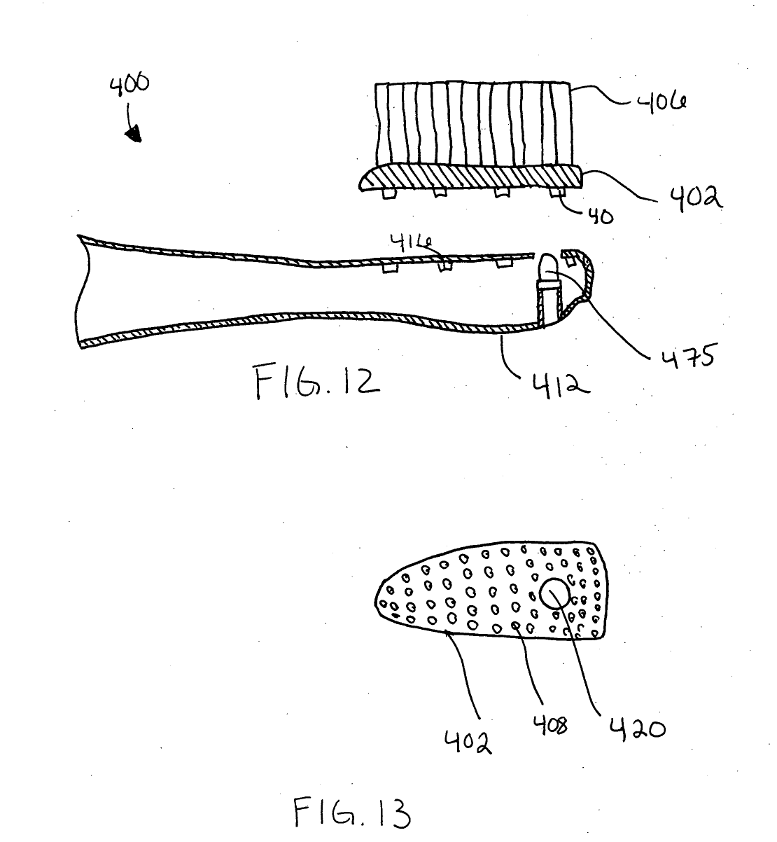

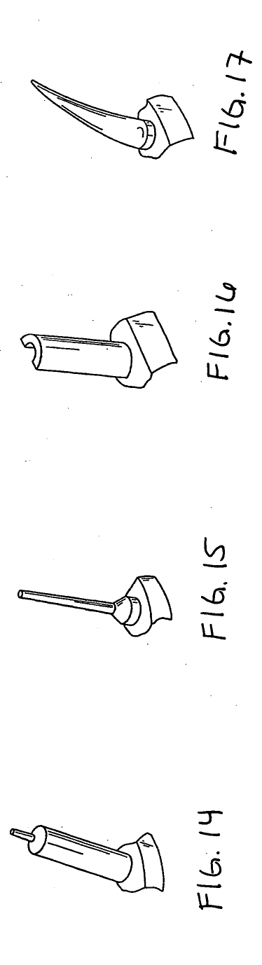

In another embodiment 400 the head of the toothbrush comprises a single bristle holder, as illustrated in FIG. 12. In this embodiment this single bristle holder 402 of the head 412 is removable and/or replaceable. This portion of the toothbrush can comprise bristles 406 which can be disposed in apertures 408 as shown in FIG. 13. This bristle holder 402 can engage the head of the toothbrush via a snap fitting, comprising protuberances 410 and apertures 416. However, it is also contemplated that the bristle holder could slide on and off via a channel and rail fitting. As shown in FIG. 13 the bristle holder comprises an aperture 420. When the bristle holder 402 engages the head 412 of the toothbrush, the electrically powered element, such as light emitting element 475 is received within, and can shine through aperture 420.

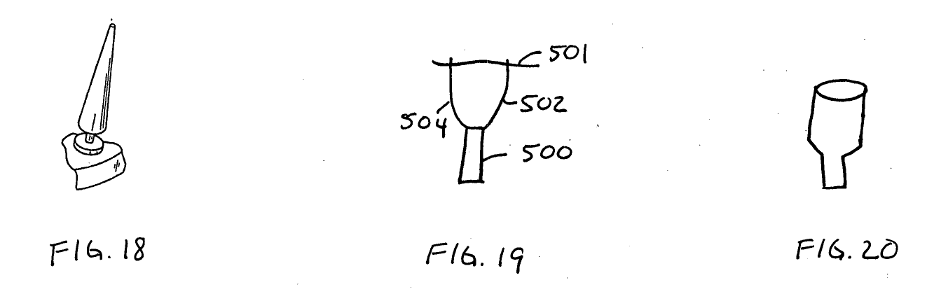

The head of the toothbrush can comprise non-bristle removable replaceable components including, but not limited to, melamine-formaldehyde foam, flossers, scrapers, elastomeric components, in particular gum massagers, scraping components, polishing cups, rubber picks, and non-elastomeric components and/or applicators, as shown in FIGS. 14-20. FIGS. 14-18 illustrate various elastomeric elements which can be used as gum massagers, scraping components, applicators and/or rubber picks. Additionally FIG. 19 illustrates a flosser, which can be used for flossing the teeth, and FIG. 20 illustrates a polishing cup which can be used for polishing the teeth. The flosser 500 comprises elements 502 and 504 which can hold a piece of dental floss 501. These components can individually engage the head of the toothbrush and/or the components can be disposed on a carrier which snaps onto and/or slidingly engages the head of the toothbrush. Additional oral care benefit can be gained from using these components in combination with an electrically powered element such as a light emitting element.

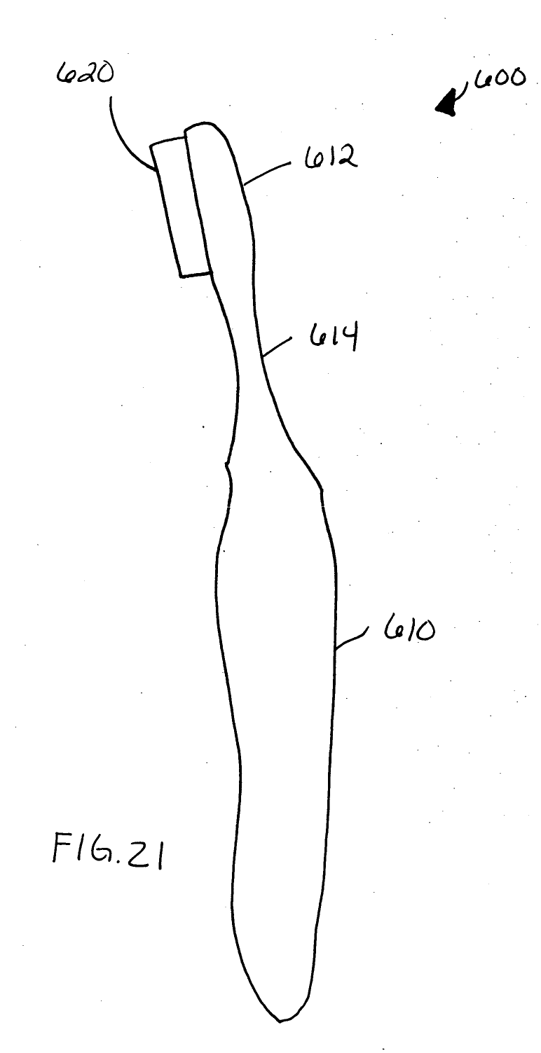

In all the aforementioned embodiments, the electrically powered element is connected to the battery via lead. These leads are not severed and/or removed during removable and/or replacement of the removable and/or replacement components. As shown in FIG. 21 one embodiment of the toothbrush having a stationary electrically powered element 75 that is connected to and/or disposed within a pillar 91 that is stationary and fixed to the head 95 at point 93 of the toothbrush. In this embodiment the moving bristle holder 97 oscillates or rotates around the stationary electrically powered element 75 disposed within pillar 91. This electrically powered element 75 disposed within the pillar 91 serves as the axis of rotation for the moving bristle holder 97 on the head 95 of the toothbrush. This embodiment of the invention has positive lead 87 and the negative lead 89 that run from the electrically powered element 75 through the pillar 91 and then down the length of the head 95 and neck (not shown) of the toothbrush to the power source (not shown) such as the battery.

In one embodiment of the present invention melamine foam is disposed on the head of the toothbrush. Melamine foam shows stain removal performance when used to clean the teeth. Melamine foam, when wetted with an appropriate solvent, such as water, removes stains from the teeth when the teeth are brought into contact with the wetted melamine foam. The wetted foam can also facilitate the removal of plaque and tartar. The removal of stains, plaque and tartar does not require the use of a detergent composition, indeed removal can occur when the melamine foam is wetted with plain water. “Bringing into contact” with the teeth includes wiping, swiping, and/or rubbing the teeth with the melamine foam. The melamine foam provides stain, plaque and tartar removal without abrading the surfaces of the teeth. A piece of melamine foam can be included on the head of an oral care implement for cleaning the teeth. This piece can span the entire head, or can cover just a portion of the head of the oral care implement. In particular a piece of foam can be disposed on a replaceable component of the oral care implement, therefore the foam piece can be replaced as needed. The melamine foam can be used on the head of a toothbrush and in combination with bristles and/or light to further enhance cleaning and/or removing stains from the teeth. It is also contemplated that a piece of melamine foam can be included on a manual toothbrush or other oral cleaning implement, and is not limited solely for use on an electric toothbrush. Further, the oral care implement comprising melamine foam does not necessarily have an electrically powered element, bristles and/or other cleaning implement disposed on the head, rather the head of the oral care implement can solely comprise a piece of melamine foam. This oral care implement can have a replaceable component, wherein the melamine foam can be replaced when desired. In this embodiment 600, as shown in FIG. 22, the oral care implement comprises a head 612, a neck 614, and a handle 610. Additionally, the oral care implement comprises a piece of melamine foam 620. This piece of foam can be disposed on a holder, and snap fitted or slidingly engaged with the head of the toothbrush; therefore allowing for replacement of the melamine foam as desired.

It is also contemplated that the electrically powered elements of the present invention are replaceable. Replacing the electrically powered element can be aided by an electric toothbrush comprising removable and/or replaceable components. The components, such as the front bristle bearing plate, of the electric toothbrush can be removed, thereby exposing the electrically powered element such that it can be replaced. The components can then be replaced on the head of the toothbrush, after the electrically powered element is replaced.

A switch is disposed on the handle for activating the motor and/or electrically powered elements. One embodiment of the electric toothbrush has a switch which includes an actuator button and a metal contact. This switch is manually depressed by pressing a molded actuator button down, which presses against a metal contact, completing the circuit, as in a conventional momentary switch. This switch allows continuous operation, through a ramp design, by depressing and sliding the actuator button forward as in a conventional continuous switch. By combining these two functions in one switch, the consumer can try the unit and see its operation prior to purchase, and still operate it continuously once out of the package. The switch can also activate one or more electrically powered elements. Preferably, the electrically powered elements are energized whenever the motor is activated. However, the toothbrush can have more than one switch to activate the electrically powered elements and/or the movable bristle holder.

In one embodiment according to the present invention a brush head comprises a pressure sensitive switch that activates the electrically powered element when something contacts the bristles or head of the toothbrush. A switch according to this design may turn the electrically powered element off as soon as the contact is severed, or automatically after certain designated amount of time. The electrically powered element can be timed to indicate how long the electric toothbrush should be used to brush the teeth, or how long the teeth or oral composition should be exposed to the emissions from the element. For example, once the bristles come into contact with the teeth, the electrically powered element switches on and remain on for about two minutes, and the electrically powered element automatically turns off. While the aforementioned switches are known, other switches can be substituted.

Additionally, a light emitting material may be used to form all or a portion of the toothbrush, including the toothbrush head and/or bristle holder. An example of such material is Ultra Glow® commercially available from Nichia America Corporation.

In each of the above-described embodiments, the light-emitting element is disposed in, on, around, below or directly adjacent the moving and/or static bristle holders so that the light is directed onto the brushing area as efficiently as possible.

A wide variety of light-emitting elements may be used with the present invention. In particular a light-emitting element that is a small, low power consumption, light emitting diode (LED) such as those commercially available under the designation Luxeon™ manufactured by Lumileds Lighting, LLC of San Jose Calif. Other commercially available preferred light emitting units include those from American Opto Plus LED Corporation

The bristles might also be colored, pigmented, or dyed to generally match the color of the light emitted by the light-emitting element. In this way, the bristle would not absorb, but reflect, the light emitted by the light-emitting element. In addition, the use of a reflective shield that assists with directing light toward the tooth or gum surfaces which is placed around or near the light-emitting element might be utilized. Additionally, the head of the toothbrush can be shaped and/or coated with a reflecting material such that light is directed towards the emitting point of the toothbrush.

Although the handle is discussed as preferably battery powered, the invention also includes other well known power supplies such as having a cord for an outlet connection or rechargeable batteries and an associated brush holder/charger (not shown).

The electric toothbrush can be packaged as a kit comprising one or more replaceable and/or removable components. In particular the electric toothbrush can be packaged with replacement bristle holders and/or front bristle bearing plates. The components can be assigned to different members of a family. Color distinction is thus often a part of the different components in a kit. Although the handle is discussed as battery powered, the invention also includes other well known power supplies such as cords for outlet connection or rechargeable batteries and an associated brush holder/charger (not shown). The kit may further include one or more packaged, light-activated oral substance and/or compositions, such as a packaged tooth whitening composition. Additionally, the kit can include other non-light activated oral care substances such as dentifrice.

All documents cited herein are, in relevant part, incorporated herein by reference; the citation of any document is not to be construed as an admission that it is prior art with respect to the present invention.

While particular embodiment of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An electric toothbrush comprising:
(a) a handle, a head, and a neck extending between said handle and said head, said handle defining a hollow interior region, said electric toothbrush having a longitudinal axis, and said head comprising bristles;
(b) said head comprising at least one electrically powered element;
(c) a motor disposed in said hollow interior region defined in said handle, which is electrically connected to said electrically powered element;
(d) at least one component wherein said component can be removed and replaced without removing said electrically powered element from said head of said toothbrush.

2. The electric toothbrush of claim 1, wherein said electrically powered element is a light emitting element.

3. The electric toothbrush of claim 2, wherein said light emitting element is a light emitting diode.

4. The electric toothbrush of claim 1, wherein said component is selected from the group consisting of a bristle holder, a front bristle bearing plate, an elastomeric component, a non-elastomeric component, an applicator and combinations thereof.

5. The electric toothbrush of claim 4, wherein at least one of said components is a bristle holder.

6. The electric toothbrush of claim 5, wherein said bristle holder comprises an aperture.

7. The electric toothbrush of claim 5, wherein at least a portion of said bristle holder is transparent.

8. The electric toothbrush of claim 5, wherein said bristle holder is a static bristle holder.

9. The electric toothbrush of claim 8, wherein said static bristle holder slidingly engages said head of said toothbrush.

10. The electric toothbrush of claim 8, wherein said static bristle holder snaps onto said head of said toothbrush.

11. The electric toothbrush of claim 5, wherein said bristle holders is a movable bristle holder.

12. The electric toothbrush of claim 11, wherein said toothbrush further comprises a drive shaft, and wherein said drive shaft operatively connects said movable bristle holder to said motor.

13. The electric toothbrush of claim 12, wherein said movable bristle holder slidingly engages said head of said toothbrush.

14. The electric toothbrush of claim 12, wherein said movable bristle holder snaps onto said head of said toothbrush.

15. The electric toothbrush of claim 2, wherein said component is a front bristle bearing plate.

16. The electric toothbrush of claim 1, wherein said electric toothbrush further comprises a switch, wherein said switch is pressure sensitive and activates said electrically powered element when said bristles of said toothbrush contact a surface.

17. The electric toothbrush of claim 1, wherein said toothbrush comprises two components, and wherein at least one component is a movable bristle holder and wherein at least one component is a static bristle holder.

18. The electric toothbrush of claim 1, wherein said electrically powered element is replaceable.

19. A kit comprising:
(a) said electric toothbrush of claim 1; and
(b) at least two of said components.

20. An electric toothbrush of claim 1, wherein at least a portion of said toothbrush comprises a light emitting material.
